(19) United States
(12) Patent Application Publication
(10) Pub. No.: US 2014/0080376 A1
(43) Pub. Date: Mar. 20, 2014

(54) ENGINEERED HIGH FIBER VOLUME POLYMER MATRIX COMPOSITES

(71) Applicant: Joseph Jalowka, Broad Brook, CT (US)

(72) Inventor: Joseph Jalowka, Broad Brook, CT (US)

(73) Assignee: United Technologies Corporation, Hartford, CT (US)

(21) Appl. No.: 13/623,297

(22) Filed: Sep. 20, 2012

(51) Int. Cl. B29C 70/44; B32B 5/26

(52) U.S. Cl. 442/205; 264/258; 428/221; 442/239

(57) ABSTRACT

A polymer matrix composites is formed from a preform layup from a plurality of fibers and is optionally tackified on its surface with a resin. The preform layup is placed in a vacuum bag and resin is flowed into the bag to infuse the layup to form a resin filled layup, then heated to increase the viscosity of the resin. The vacuum bag is vented to remove residual resin and/or entrapped gas, applying pressure to the preform layup in the bag to consolidate the layup to the target fiber volume, and the resin is cured.

### BACKGROUND

Polymer matrix composites, hereinafter PMC, include a reinforcing fiber/fabric such as: fiberglass, Kevlar, or carbon. They also contain a resin matrix such as: epoxy, bismaleimide, or polyimide which binds together the plies of the reinforcement. Available technologies for fabrication of components using PMCs include but are not limited to: preimpregnated fabrics or tapes which are produced using autoclave or compression molding processes.

Other processes use dry fiber/fabric reinforcement and infuse the resin into the preform. In one infusion process, the preform is constrained within a matched metal mold and the infusion is facilitated by applying pressure to the resin. This process is known as Resin Transfer Molding (RTM).

Another infusion process is one in which dry fiber/fabric reinforcement plies are combined with films/sheets of resin. Once the layup is completed pressure and heat is applied to the plies, either using an autoclave or similar device, and the resin flows in the through thickness direction to infuse the dry preform. This process is known as resin film infusion (RFI).

Still another infusion process that utilizes dry fabric preforms, uses a tool on one surface, and a bag on the opposite surface. Resin flows into the preform by drawing vacuum on the reinforcement plies contained within the bag. The preform can either be heated or at room temperature depending on the viscosity of the resin. Once the preform is fully saturated with resin, the vacuum source is removed, and the inlet and outlet to the bag is closed, and the resin is cured typically using heat. This process is known as Vacuum Assisted Resin Transfer Molding (VaRTM).

Each of the described processes has drawbacks for producing aerospace parts having complex shapes or contours. While pre-impregnated fabrics and tapes molded in an autoclave give the necessary high fiber volume with low void content desired for structural composite parts, this process is typically expensive, and is labor intensive to use. This process requires a high labor content to cut and position plies. Depending on the part geometry, several debulking steps (placing a vacuum bag over the layup at room temperature) could be required to get the laminate closer to net thickness prior to cure. Resin Transfer molding (RTM) requires expensive two sided tooling in order to manufacture parts. RTM tooling can be expensive to produce for parts with a high degree of contour and complexity. RTM tooling also tends to be fairly heavy in order to withstand the resin pressure applied during injection. This increased mass can require longer heat up times which increases the overall part cycle time. Fiber volume content of RTM structures can vary widely depending on the part geometry. It is difficult for dry or tackified fabric plies to maintain position in these parts, and therefore it is difficult to obtain uniformly high fiber volumes (near 60%) for parts that have complex geometries.

Resin film infusion (RFI) has many the same labor cost issues as preimpregnated fabrics and tapes. VaRTM processing using vacuum only limits the amount of compaction that can be achieved and therefore lower laminate fiber volumes result. Typically fiber volumes greater than 50% are difficult to achieve using VaRTM. Also if there is any air or other volatiles present during the infusion, they typically get trapped in the laminate to create porosity. The combination of lower fiber volume and porosity negatively affects the in-plane mechanical properties and limits the use of VaRTM as a viable process for aerospace composites.

### SUMMARY

The present invention provides for structural composite components for the aerospace industry. The composites are produced by Vacuum Assisted Resin Transfer Molding (hereinafter VaRTM), using dry reinforcements and bulk resin to produce higher fiber volumes. A layup is formed from dry fiber/fabric, uni-directional tape/fabrics, braid, or 3D woven structures. The layup may be surface tackified with a resin, either thermoset or thermoplastic, catalyzed or non-catalyzed, to increase the toughness of the fiber/resin interface.

The layup is then sealed in a vacuum bag with flow distribution media on the top and bottom surfaces of the laminate. The vacuum bag is heated and resin is infused into the preform by drawing vacuum on the fiber/fabric layup. The laminate is then heated to a temperature that increases the resin viscosity so the plies are consolidated under pressure. The bag is opened to allow residual resin or entrapped gas to escape, and the laminate is subjected to eternal pressure, such as from about 100 to 150 psi and heated to cure temperature. Fiber volumes in excess of 60% and void volumes less than 2% are achieved.

### BRIEF DESCRIPTION OF THE DRAWINGS

FIG. 1 is a schematic view of the method and apparatus of this invention.

FIG. 2 is a block flow diagram showing the method of this invention.

### DETAILED DESCRIPTION

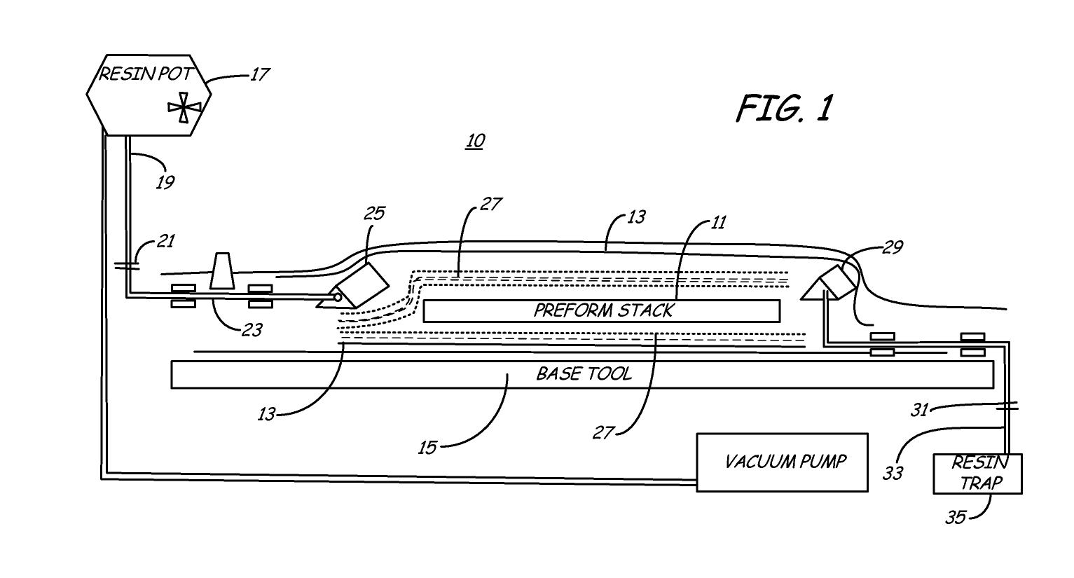

A VaRTM bagging apparatus 10 is shown in FIG. 1. Prior to use, a preform stack or layup 11 is formed from dry fiber/fabric, uni-directional tape/fabrics, braid, or 3D woven structures. Layup 11 may be surface tackified with a resin, either thermoset or thermoplastic, catalyzed or non-catalyzed, to increase the toughness of the fiber/resin interface. Layup 11 is then placed in apparatus 10 in double vacuum bag 13 on base tool 15. Bag 13 is nonporous and may be made from fibers such as, but not limited to polytetrafluoroethylene fibers.

Resin pot 17 contains the thermoset or thermoplastic resin, catalyzed or non-catalyzed, that is mixed in resin pot 17 and degassed. Resin flows in inlet line 19 and the flow is controlled by valve 21, after which the resin enters copper line 23 to flow into resin flow channel 25. Porous distribution media armalon layers 27 are located on both sides of layup 11. Armalon 27 is made from fibers such as polytetrafluoroethylene fibers and is porous. Resin flows from flow channel 25 to infuse layup 11 and through resin flow channel 29 leading to valve 31 and outlet 33. Once the layup 11 fills with resin, resin appears in outlet 33. Both valve 21 and valve 31 are closed and layup 11 is heated, with heat from base tool 15, for example, to a temperature that increases the viscosity to a level higher than typical for infusion but low enough to allow layup 11 to be consolidated under pressure. Pressure may range from about 100 psi to about 150 psi, or more or less. Pressure is used to compact layup 11 to a targeted fiber volume.

External pressure is applied to layup 11, by base tool 15, for example, and resin outlet valve 31 is opened. When valve 31 is opened, residual resin or entrapped gas escapes layup 11 via outlet 33 into resin trap 35. Layup 11 is then heated to the cure temperature.

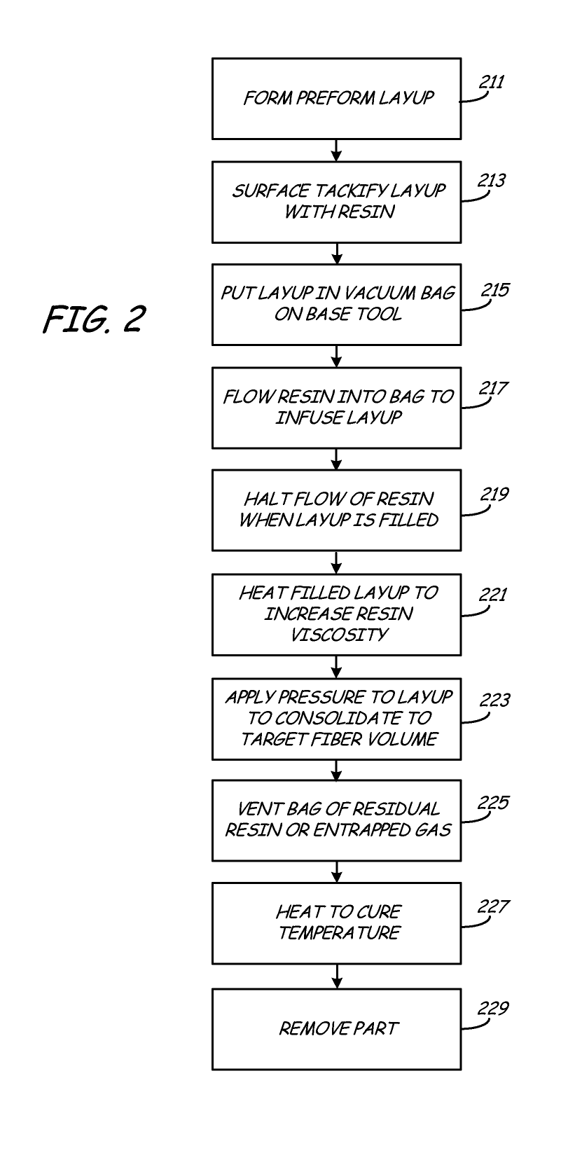

FIG. 2 illustrates the method of this invention in block flow diagram. A preform layup is formed as described above in step 201. The surface of the layup may be tacified with a resin in step 213, though this step is not essential. The layup is then put in a vacuum bag as described above on a base tool in step 215.

Resin flows into the bag to infuse the layup in step 217. Flow is halted in step 219 when the layup is filled with resin.

The resin filled layup is then heated to increase the viscosity of the resin in step 221 and pressure is applied to the layup to consolidate the layup to the target fiber volume in stop 223. Step 225 consists of venting the bag to dispose of residual resin or entrapped gas, The layup is heated to a cure temperature in step 227 where the resin cures. Finally, the completed part is removed from the apparatus in step 229.

Fiber volume in excess of 60% and void volumes les than 2% are achieved. This permits manufacture of parts with more complicated shapes having less weight, thus improving the overall operation of the device into which the parts are more weight efficient. For example, lightweight fan containment cases for gas tubrofan engines are more efficiently made and have lighter weight.

### DISCUSSION OF POSSIBLE EMBODIMENTS

The following are nonexclusive descriptions of possible embodiments of the present invention.

A method of forming structural composite components for the aerospace industry in which a preform is formed from a plurality of fibers, then placed in a vacuum bag with one surface facing up. Resin is flowed into the bag to infuse the preform, and then the preform is heated to increase the viscosity of the resin. The bag is vented to remove residual resin and entrapped gas. Further heat is applied to cure the resin and form a polymer matrix composite.

The method of the preceding paragraph can optionally include additionally and/or alternatively, any one or more of the following features, configurations and/or additional components.

The preform layup is optionally formed from at least one of dry fiber/fabric, uni-directional tape/fabrics, braid, and 3D woven structures.

The surface of the preform can be tackified with a resin prior to placement in the vacuum bag and the resin can be selected from selected from thermoset resins, thermoplastic resins, catalyzed resins and non-catalyzed resins.

Pressure may be applied to the preform when it is in the bag.

The preform can be enclosed with a porous distribution media on both sides of preform layup prior to infusion with resin. The porous distribution media may be polytetrafluoroethylene or similar fibers.

The resulting polymer composite matrix can have a fiber volume in excess of 60% and void volumes less than 2%.

A polymer matrix composite having a fiber volume in excess of 60% and void volumes less than 2%, formed from a plurality of fibers, then placed in a vacuum bag with one surface facing up. Resin is flowed into the bag to infuse the preform, and then the preform is heated to increase the viscosity of the resin. The bag is vented to remove residual resin and entrapped gas. Further heat is applied to cure the resin and form a polymer matrix composite.

The polymer matrix composite of the preceding paragraph can optionally include additionally and/or alternatively, any one or more of the following features, configurations and/or additional components.

The preform layup is optionally formed from at least one of dry fiber/fabric, uni-directional tape/fabrics, braid, and 3D woven structures.

The surface of the preform can be tackified with a resin prior to placement in the vacuum bag and the resin can be selected from selected from thermoset resins, thermoplastic resins, catalyzed resins and non-catalyzed resins.

Pressure may be applied to the preform when it is in the bag.

The preform can be enclosed with a porous distribution media on both sides of preform layup prior to infusion with resin. The porous distribution media may be polytetrafluoroethylene or similar fibers.

The resulting polymer composite matrix can have a fiber volume in excess of 60% and void volumes less than 2%.

A method of manufacturing a polymer matrix composite by forming a preform layup from a plurality of fibers selected from dry fiber/fabric, uni-directional tape/fabrics, braid, or 3D woven structures, tackifying a surface of the preform layup with a resin, then placed in a vacuum bag with one surface facing up. Resin is flowed into the bag to infuse the preform, and then the preform is heated to increase the viscosity of the resin. The bag is vented to remove residual resin and entrapped gas. Further heat is applied to cure the resin and form the polymer matrix composite.

The polymer matrix composite of the preceding paragraph can optionally include additionally and/or alternatively, any one or more of the following features, configurations and/or additional components.

The surface of the preform can be tackified with a resin prior to placement in the vacuum bag and the resin can be selected from selected from thermoset resins, thermoplastic resins, catalyzed resins and non-catalyzed resins.

The preform can be enclosed with a porous distribution media on both sides of preform layup prior to infusion with resin. The porous distribution media may be polytetrafluoroethylene or similar fibers.

The resulting polymer composite matrix can have a fiber volume in excess of 60% and void volumes less than 2%.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method comprising:
forming a preform layup from a plurality of fibers and having an upper surface;
placing the preform layup in a vacuum bag;
flowing resin into the bag to infuse the layup to form a resin filled layup;
heating the resin filled layup to increase viscosity of the resin;
venting the vacuum bag to remove residual resin and/or entrapped gas;
further heating the resin filled layup to cure the resin and form a polymer matrix composite; and
remove the polymer matrix composite from the vacuum bag.

2. The method of claim 1, wherein the preform layup is formed from at least one of dry fiber/fabric, uni-directional tape/fabrics, braid, and 3D woven structures.

3. The method of claim 1, wherein the surface of the preform layup is tacified with a resin prior to placement in the vacuum bag.

4. The method of claim 3, wherein the preform layup surface is tackified with a resin selected from thermoset resins, thermoplastic resins, catalyzed resins and non-catalyzed resins.

5. The method of claim 1, wherein pressure is applied to the preform layup in the bag.

6. The method of claim 1, wherein the preform layup is enclosed with a porous distribution media on both sides of preform layup prior to infusion with resin.

7. The method of claim 6, wherein the porous distribution media is formed from polytetrafluoroethylene or similar fibers.

8. The method of claim 1, wherein the polymer composite matrix has a fiber volume in excess of 60% and void volumes less than 2%.

9. A polymer matrix composite having a fiber volume in excess of 60% and void volumes less than 2%, the composite being formed by:
forming a preform layup from a plurality of fibers;
placing the preform layup in a vacuum bag;
flowing resin into the bag to infuse the layup to form a resin filled layup;
heating the resin filled layup to increase the viscosity of the resin;
venting the vacuum bag to remove residual resin and/or entrapped gas;
further heating the resin filled layup to cure the resin and form a polymer matrix composite; and
removing the polymer matrix composite.

10. The composite of claim 9, wherein the preform layup is formed from at least one of dry fiber/fabric, uni-directional tape/fabrics, braid, and 3D woven structures.

11. The composite of claim 9, wherein the surface of the preform layup is tackified with a resin prior to placement in the vacuum bag.

12. The composite of claim 11, wherein the preform layup surface is tackified with a resin selected from thermoset resins, thermoplastic resins, catalyzed resins and non-catalyzed resins.

13. The composite of claim 9, wherein pressure is applied to the preform layup in the bag.

14. The composite of claim 9, wherein the preform layup is enclosed with a porous distribution media on at least one side of preform layup prior to infusion with resin.

15. The composite of claim 14, wherein the porous distribution media is formed from polytetrafluoroethylene or similar fibers.

16. A method of manufacturing a polymer matrix composites, comprising:
forming a preform layup from a plurality of fibers selected from dry fiber/fabric, uni-directional tape/fabrics, braid, or 3D woven structures;
tackifying a surface of the preform layup with a resin;
placing the preform layup in a vacuum bag;
flowing resin into the bag to infuse the layup to form a resin filled layup;
heating the resin filled layup;
venting the vacuum bag to remove residual resin and/or entrapped gas;
applying pressure to the preform layup in the bag to consolidate the layup to the target fiber volume;
further heating the resin filled layup to cure the resin and form the polymer matrix composite; and
removing the polymer matrix composite.

17. The method of claim 16, wherein the preform layup surface is tackified with a resin, either thermoset or thermoplastic, catalyzed or non-catalyzed.

18. The method of claim 16, wherein the preform layup is enclosed with a porous distribution media on both sides of preform layup prior to infusion with resin.

19. The method of claim 18, wherein the polymer composite matrix has void volumes les than 2%.

20. The method of claim 16, wherein the polymer composite matrix has a fiber volume in excess of 60%.
